(19) United States
(12) Patent Application Publication
(10) Pub. No.: US 2010/0283188 A1
(43) Pub. Date: Nov. 11, 2010

(54) METHOD AND DEVICE FOR THE GENERATIVE PRODUCTION OF A SHAPED BODY HAVING NON-PLANAR LAYERS

(75) Inventors: Gottfried ROHNER, Altstatten (CH); Wolfgang WACHTER, Schaan (LI); Jürgen STAMPFL, Wien (AT); Johannes PATZER, Wien (AT); Johannes HOMA, Wien (AT)

Correspondence Address: NIXON PEABODY LLP - PATENT GROUP, 1100 CLINTON SQUARE, ROCHESTER, NY, 14604, US

(73) Assignees: IVOCLAR VIVADENT AG, Schaan (LI); TECHNISCHE UNIVERSITAT WIEN, Wien (AT)

(21) Appl. No.: 12/568,926

(22) Filed: Sep. 29, 2009

(30) Foreign Application Priority Data
May 11, 2009 (EP) 09159894.6

(51) Int. Cl. B29C 35/08

(52) U.S. Cl. 264/401; 425/174.4

(57) ABSTRACT

The present invention relates to a method for the generative production of a shaped body (27) of material (5, 55) solidifiable under the effect of electromagnetic radiation, in particular a green compact for dental restoration, by means of a multiplicity of exposure steps (1001, 1002, 1003, 1004), characterized in that a new layer of material (5, 55) solidifiable under the effect of electromagnetic radiation, having a layer thickness which is less than or equal to half the penetration depth of the electromagnetic radiation into the solidifiable material (5, 55), is provided before an exposure step (1001, 1002, 1003, 1004), the layer provided is exposed in the exposure step (1001, 1002, 1003, 1004) only in a subregion (2001, 3001) of the shaped body layer to be formed, and a layer provided before a preceding exposure step, on which the new layer has been provided, being solidified together with the new layer in the exposed subregion (2001, 3001), and the exposed subregion (2001, 3001) is varied between the exposure steps (1001, 1002, 1003, 1004).

This application claims the benefit of European Patent Application

Serial No. 09159894.6, filed May 11, 2009, which is hereby incorporated by reference in its entirety.

### FIELD

The present invention relates to a method and a device for the generative production of a shaped body of material solidifiable under the effect of electromagnetic radiation, by use of a multiplicity of exposure steps. The invention is useful in particular for the construction of shaped bodies which are used as a green compact for dental restoration.

### BACKGROUND

CAD-CAM technologies have already been gaining acceptance in the field of dentistry for some time, and are replacing the traditional manual production of dentures. The nowadays conventional material removal production methods for generating ceramic dental restoration bodies have some disadvantages, however, which cannot be improved according to the state of the art with reasonable outlay in economic terms. In this context material application production methods known by the term “generative manufacture” may be considered, in particular stereolithographic methods in which a newly applied material layer is polymerized in the desired shape by position-selective exposure, so that by successive layer-wise forming the desired body is produced in its three-dimensional shape which results from the succession of applied layers.

A problem with the method of layer-wise production from photopolymerizable material is the mutual coherence of the individual layers. When shear forces of the layers act on one another, they may lose adhesive contact with one another and the shaped body may become delaminated.

### SUMMARY

It is therefore an object of the present invention to provide a method and a device for the generative production of a shaped body of material solidifiable under the effect of electromagnetic radiation, wherein increased strength of the shaped body is achieved.

This object is achieved by the method and the device according to the present invention. Advantageous configurations of the invention are the subject-matter of the specification.

The method according to the invention is characterized in that a new layer of material solidifiable under the effect of electromagnetic radiation, having a layer thickness which is less than or equal to half the penetration depth of the electromagnetic radiation into the solidifiable material, is provided before an exposure step, the layer provided is exposed in the exposure step only in a subregion of the shaped body layer to be formed, a layer provided before a preceding exposure step, on which the new layer has been provided, being solidified together with the new layer in the exposed subregion, and the exposed subregion is varied between the exposure steps. This alternate partial exposure thus leads to the formation of interlocked non-planar layers.

The effect achieved by the method according to the invention is that the individual layers do not form a surface-wide connection point with one another; rather, each layer except for the first and last layers will have been solidified together in one subregion with the layer lying above in one exposure step and in another subregion with the layer lying below in a second exposure step. The first and last layers are thereby solidified together with the subsequent and preceding layers, respectively, in a subregion. This achieves a particularly well-interlocked layer composite with an increased mutual bonding strength of the individual layers, and an increased strength of the solid body is therefore achieved. It should be mentioned at this point that not all of the shaped body must consist exclusively of layers interlocked in this way; rather, particular regions such as lateral edge regions or outer-lying layers may have planar layer bonds without such interlocking Mutual interlocking of the layers over a majority of the shaped body, however, guarantees that the shaped body will not become delaminated even in the event of high shear forces between the layers.

In the method according to the invention, it is preferred to ensure on the one hand that the penetration depth of the electromagnetic radiation into the solidifiable material extends over at least two layers, so that at least two layers per exposure step can be solidified in the exposed subregion, and on the other hand that a new layer is provided before each exposure step. Although only the layer provided immediately before the exposure step is then exposed directly in the subregion, the electromagnetic radiation nevertheless also reaches one or more underlying layers which were provided before exposure steps carried out previously.

The penetration depth of the electromagnetic radiation into the solidifiable material is defined in the scope of this invention as the depth over which the solidifiable material is solidified strongly enough, when the solidifiable material is exposed over a defined period of time in an exposure step to electromagnetic radiation with a defined intensity and defined wavelength spectrum. In this context, it will be clear to the person skilled in the art that the maximum layer thickness of the method according to the invention may depend on the duration and the type of the exposure. Using an exposure unit with a medium intensity of from 0.1 mW/cm² to 100 mW/cm² and an exposure time of 6 s per exposure step may give a penetration depth of the electromagnetic radiation of about 50-250 μm into the solidifiable material, a layer thickness of 25 μm or less advantageously being selected. Besides the aforementioned type and nature of the exposure, the penetration depth of the electromagnetic radiation into the solidifiable material will also depend on the solidifiable material being used. The solidifiable material may in particular have various types of absorbers, in which case the penetration depth of the electromagnetic radiation into the solidifiable material will be also determined crucially by the choice of absorber being used.

According to a preferred embodiment, the luminous power may respectively be increased during a single exposure step, in particular continuously, in order to achieve better setting at greater depths.

It should be noted that the exposed subregions may readily intersect between successive exposure steps, so that the electromagnetic radiation also acts on already solidified regions of one or more deeper-lying layers. It is however preferable for the subregions varied between the exposure steps essentially not to overlap, and for them to add together to give the shaped body layer to be formed. Here, “essentially” means that it is not necessary to ensure that there cannot be any very minor overlap in the edge regions between the exposed subregions, which may occur inter alia because of scattered light effects; rather, there may be minor overlap in the edge regions between the exposed subregions. The effect advantageously achieved by this is that, apart from scattered light effects, each subregion of a layer is exposed to the influence of the electromagnetic radiation only in precisely one exposure step and an accurately defined exposure time.

The shaped body layer to be formed will thus preferably be exposed in two or more subregions, which essentially do not form an intersection set with one another, over correspondingly many exposure steps, a different one of the subregions always being exposed in successive exposure steps. Since a new layer is always provided between the exposure steps, the penetration depth of the electromagnetic radiation into the solidifiable material must extend at least over as many layers as there are different subregions exposed.

The number of subregions, which add together to form the shaped body layer to be formed, is thus not restricted to two. Particularly for the case in which the layer thickness is selected to be so thin that the penetration depth of the electromagnetic radiation into the solidifiable material extends over more than two layers, correspondingly many subregions may be defined, for example by using corresponding exposure masks. Then, as many layers will be solidified together per exposure step in each subregion as the penetration depth of the electromagnetic radiation into the solidifiable material allows.

It may furthermore be advantageous for a first subregion to be exposed using a first exposure mask and for a second subregion to be exposed using a second exposure mask, the first exposure mask essentially being complementary with the second exposure mask, and exposure being carried out using one exposure mask in every second exposure step and using the other exposure mask in the other respective exposure steps. For example, the geometry of the first subregion may be configured like the white squares of a chessboard pattern and the geometry of the second subregion may be configured like the black squares of a chessboard pattern, although other mutually complementary patterns may be used in any desired way. In this embodiment, the penetration depth should advantageously extend over only two layers.

The term “exposure mask” is to be understood here in the widest sense, i.e. that it covers any form of intensity modulation with which a defined intensity pattern with desired subregions is imaged onto the exposure field. The exposure masks used may be analogue cover masks or digital mask arrays such as so-called DLP chips (digital light processing chips), for example micromirror arrays, LCD arrays and the like, which can be driven in order to image a particular intensity pattern with desired subregions onto the exposure field. As an alternative, the exposure mask may also be a preprogrammed operating programme of a laser beam, with which the laser beam successively scans the exposure field only in a desired subregion and only solidifies the material there.

The shaped body to be produced generatively by the method according to the invention may for example be a green compact for dental restoration, in which case the material solidifiable under the effect of electromagnetic radiation may be a photopolymerizable material such as a ceramic-filled photopolymer.

A plastic may advantageously be used in the method according to the invention for producing the shaped body, the shaped body being embedded in an embedding compound after its production and burnt out after solidification of the embedding compound, and another material, in particular a dental ceramic material or metal or an alloy, being pressed into the resulting cavities in the embedding compound.

In a preferred method, a dental composite may be used for producing the shaped body and the shaped body may be processed after its production and subsequently polished or coated and subsequently processed.

In a method according to the invention, the ceramic component of the ceramic-filled photopolymer preferably consists of an oxide ceramic or a glass ceramic, in particular zirconium oxide, aluminium oxide, lithium disilicate, leucite glass ceramic, apatite glass ceramic or mixtures thereof.

The device according to the invention is characterized in that it has an exposure unit, a first exposure mask and a second exposure mask, and exposure unit and a control unit. The exposure unit is capable of exposing the shaped body layer to be formed to electromagnetic radiation. The first exposure mask allows only a first subregion of the shaped body layer to be formed to be exposed, and the second exposure mask allows only a second subregion of the shaped body layer to be formed to be exposed, the first subregion being different from the second subregion. The coating unit is capable of providing a new layer of material solidifiable under the effect of electromagnetic radiation, having a layer thickness which is less than or equal to half the penetration depth of the electromagnetic radiation into the solidifiable material. Lastly, the control unit is configured and adapted to control the device so that a new layer previously provided by the coating unit is exposed using the first exposure mask in one exposure step and a next new layer previously provided by the coating unit is exposed using the second exposure mask in the subsequent exposure step.

The device according to the invention particularly rapidly and accurately makes it possible for the individual layers, except for the first and last layers, to have been solidified together in one subregion with the overlying layer in one exposure step, and to have been solidified together in another subregion with the underlying layer in another exposure step. The first and last layers are solidified together only with the subsequent or preceding layer, respectively, in one subregion.

Preferably, the coating unit has a trough which has an at least partially transparently designed bottom and can be filled with a photopolymerizable material, a structure platform is held by a travelling mechanism over the trough bottom so that its height relative to the trough bottom is adjustable, and the control unit is adapted to adjust the position of the structure platform relative to the trough bottom for a layer after each exposure step by controlling the travelling mechanism.

This makes it possible for particularly thin layers to be provided in a particularly rapid way with a uniform and defined coating thickness and layer thickness. With respect to the device according to the invention, a “coating thickness” is to be understood here as the thickness, provided by the coating unit, of the solidifiable material into which the structure platform or already solidified layers of the shaped body are immersed for a subsequent exposure step. The “layer thickness” provided by the coating unit, on the other hand, can be given for a particular immersion depth by the distance between the transparent trough bottom and the structure platform or the shaped body's layer last solidified in a subregion. The solidifiable material's coating thickness provided on the trough bottom may for example be 300 μm so that the structure platform, or the last layer solidified in a subregion, can be immersed to a depth of 275 μm into the solidifiable material in order to achieve a layer thickness of 25 μm between the transparent trough bottom and the structure platform, or the last layer solidified in a subregion.

It is advantageous for the exposure unit to be arranged below the trough bottom for exposure from below through the at least partially transparent trough bottom. Exposure can therefore be carried out directly from below and without complicated light beam guidance.

In a preferred embodiment of the device according to the invention, the travelling mechanism contains a force transducer which is connected to the control unit and is capable of measuring the force exerted by the travelling mechanism on the structure platform and sending the measurement result to the control unit, the control unit being adapted to move the structure platform with a predetermined force profile.

Particularly in the case of ceramic-filled photopolymerizable materials, owing to their high viscosity, large forces may occur when lowering the structure platform into the viscous material or lifting the structure platform out of the viscous material, which are caused by the viscous material being squeezed out or sucked in between the structure platform and the trough bottom. In order to restrict the forces encountered but still allow as high as possible a lowering or lifting speed, which accelerates the production process overall, the control unit may employ the travelling mechanism optimally with force control by virtue of a force measurement.

In order to achieve a maximally uniform and exactly predeterminable exposure thickness of photopolymerizable material over the trough bottom, the device according to the invention is preferably constructed as follows. The trough is mobile in the horizontal direction relative to the projecting exposure unit and the structure platform. An application device whose height above the trough bottom is adjustable, for example a doctor blade or a roller, is arranged before the exposure unit in the movement direction. The application device, extending with a lower edge parallel to the trough bottom, smoothes the photopolymerizable material to a uniform thickness before it reaches the polymerization region between the exposure unit and the structure platform.

Advantageously, the trough may be mounted rotatably about a central rotation axis, the projecting exposure unit lying below the trough bottom and the structure platform lying above being offset in the radial direction relative to the central rotation axis, and a drive is provided which is capable of a rotating the trough under the control of the control unit between successive exposure steps by a predetermined angle about the central rotation axis, with a delivery instrument for delivering photopolymerizable material into the trough, the application device and the exposure unit following one another in the movement direction.

This design achieves a particularly compact arrangement of the components of the device. It is in this case preferable for a squeegee, which is positionable at a predeterminable height above the trough bottom and is configured for redistribution of the material after the solidification process in the exposed subregion, to be provided behind the region of the projecting exposure unit in the rotation direction.

In all the embodiments, light-emitting diodes may be used as the light source for the exposure unit. The light-emitting diodes are then preferably configured to emit light with different light wavelengths.

It has been shown that it is advantageous for the exposure unit to project light with an average intensity of from 100 mW/dm² to 2000 mW/dm², in particular from 500 mW/dm² to 2000 mW/dm², onto the exposure field.

### BRIEF DESCRIPTION OF THE DRAWINGS

The invention will be described below with the aid of an exemplary embodiment with reference to the drawings, in which:

FIG. 1 shows a lateral plan view, partially in section, of a device according to the invention,

FIG. 2 shows a plan view of the device in FIG. 1 from above,

FIGS. 3 to 5 show a partial section of the device in FIG. 1 in the region of the structure platform and the trough bottom in successive working steps,

FIG. 6 shows a plan view from above for a second embodiment of the invention,

FIG. 7 shows a lateral plan view, partially in section, of the device of the second embodiment in FIG. 6,

FIG. 8 shows a plan view from above of a third embodiment of the invention,

FIGS. 9a-d show schematic details of a cross section of a shaped body to be constructed, before and after a plurality of exposure steps, and

FIGS. 10a,b show schematic details of a plan view of a shaped body to be constructed after every second exposure step, and the exposure steps carried out between them, respectively.

### DETAILED DESCRIPTION

The following exemplary embodiment relates to the production of a green compact for dental restoration.

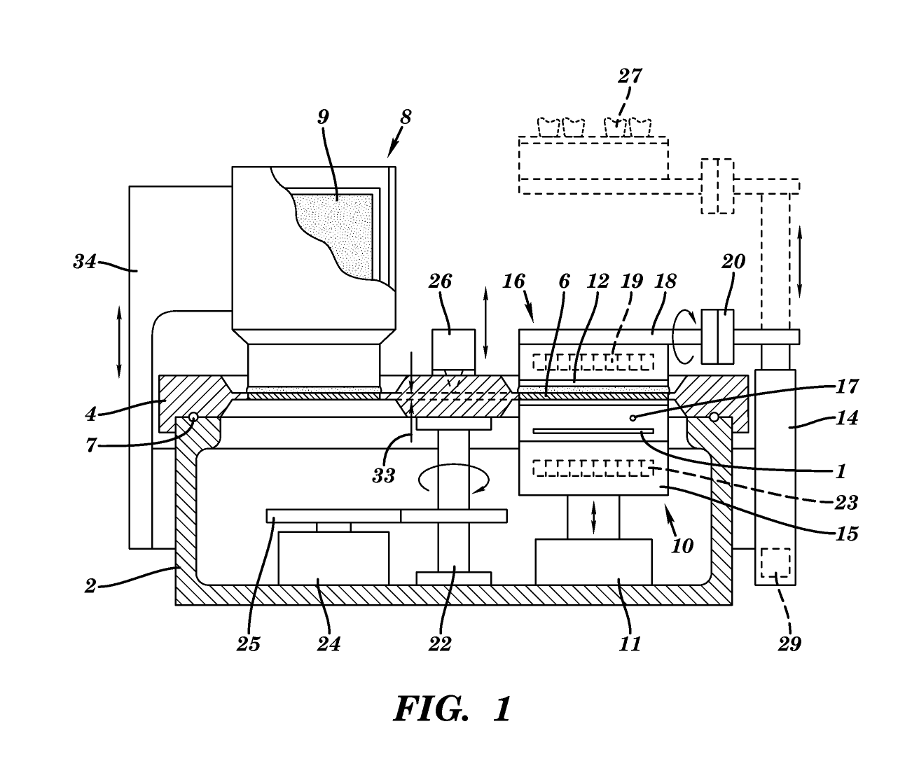

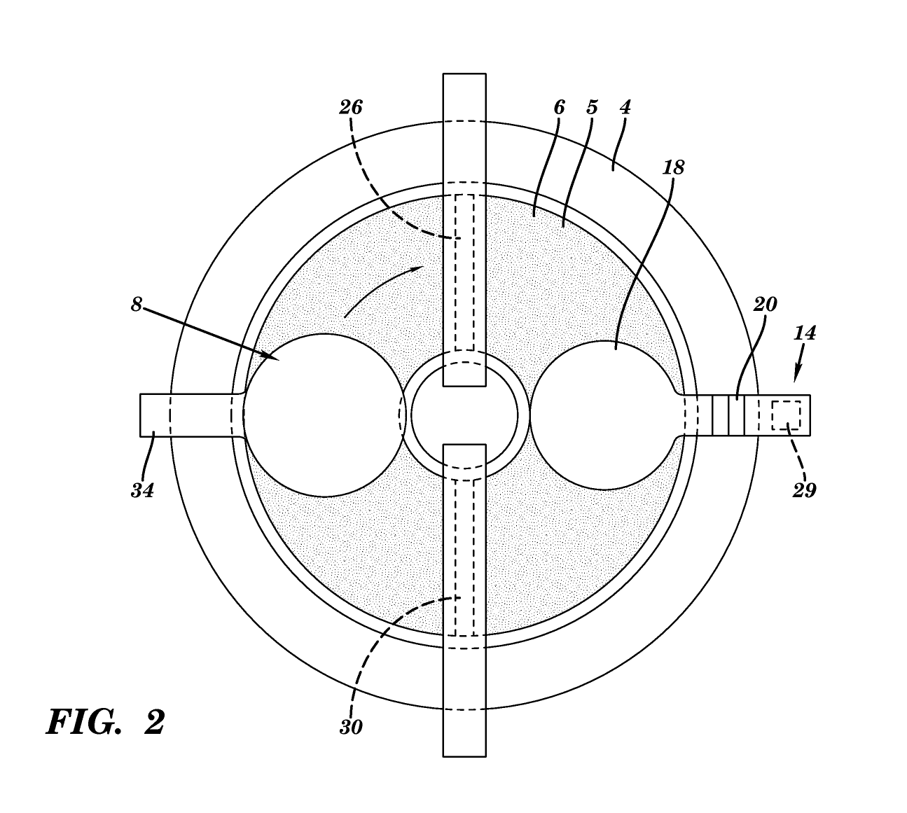

First, the main components of the device will be described with reference to FIGS. 1 and 2.

In the embodiment represented in FIGS. 1 and 2, the device has a housing 2 which is used to accommodate and fit the other components of the device.

The upper side of the housing 2 is covered by a trough 4, which has a transparent and plane trough bottom at least in the regions intended for the exposures.

Below the trough bottom 6 in the housing 2, a projecting exposure unit 10 is provided which can expose a predetermined exposure field on the lower side of the trough bottom 6 selectively to a pattern with the desired geometry under the control of a control unit 11.

The projecting exposure unit 10 preferably has a light source 15 with a plurality of light-emitting diodes 23, a luminous power of about 15 to 20 mW/cm² preferably being achieved in the exposure field. The wavelength of the light emitted by the exposure unit preferably lies in the range of from 350 to 500 nm. The light from the light source 15 is modulated position-selectively in its intensity by a light modulator 17 and imaged in the resulting intensity pattern with the desired geometry onto the exposure field on the lower side of the trough bottom 6. Various types of so-called DLP chips (digital light processing chips) may be used as light modulators, for example micromirror arrays, LCD arrays and the like. As an alternative, a laser whose light beam scans the exposure field by means of a mobile mirror, which can be controlled by the control unit, may be used as the light source.

Above the projecting exposure unit 10, on the other side of the trough bottom 6, a structure platform 12 is provided which is held by a travelling mechanism 14 with a supporting arm 18 so that it is held in a height-adjustable way over the trough bottom 6 above the exposure unit 10. The structure platform 12 is likewise transparent or translucent.

Above the structure platform 12, a further exposure unit 16 may be arranged which is likewise driven by the control unit 11 in order to shine light from above through the structure platform 12 as well when forming the first layer below the structure platform 12, so as to achieve secure and reliably reproducible polymerization and adhesion of the first polymerized layer on the structure platform 12. This, however, is not categorically necessary for a layer thickness which is half the penetration depth of the light into the photopolymerizable material or less.

Above the surface of the trough 4, a delivery instrument 8 is furthermore provided, having a reservoir in the form of a replaceable cartridge 9 filled with photopolymerizable material. Ceramic-filled photopolymerizable material can successively be supplied from the delivery instrument 8 onto the trough bottom 6 under the control of the control unit 11. The delivery instrument is held by a height-adjustable support 34.

The trough 4 is mounted rotatably about a vertical axis 22 on the housing 2 by means of a bearing 7. A drive 24 is provided, which puts the trough 4 into a desired rotation position while being driven by the control unit 11.

In the rotation direction between the exposure unit 12 and the delivery instrument 8, a squeegee 30 may be arranged with an adjustable height above the trough bottom 6, which may fulfil various functions as explained below.

As may be seen from FIG. 2, between the delivery instrument 8 and the exposure unit 12 there is an application device 26 above the trough bottom 6, here in the form of a doctor blade 26 which can be positioned at an adjustable height above the trough bottom 6 so as to smooth material which has been supplied from the delivery instrument 8 onto the trough bottom 6, before it reaches the exposure unit 12, in order to ensure a uniform and predetermined coating thickness. As an alternative or in addition to the doctor blade, the application device may comprise one or more rollers or further doctor blades in order to exert a smoothing effect on the material layer.

The swivel arm 18 carrying the structure platform 12 is connected by a rotary articulation 20 to the vertically displaceable part of the travelling mechanism 14. The travelling mechanism 14 furthermore contains a force transducer 29, which measures the force exerted by the travelling mechanism 14 on the structure platform 12 when lowering or raising the latter, and sends the measurement result to the control unit 12. As explained below, this is configured to control the travelling mechanism 14 according to a predetermined force profile, for example so that the force exerted on the structure platform 12 is limited to a maximum value.

The functionality of the device as represented in FIGS. 1 and 2 may be summarized as follows. From the delivery instrument 8, while being controlled by the control unit, a predetermined material quantity of ceramic-filled photopolymerizable material 5 is delivered onto the trough bottom 6. By operating the drive 24, the control unit 11 induces rotation of the trough bottom 6 about the rotation axis 22 so that the delivered material passes through the application device 26, here a doctor blade, which smoothes the photopolymerizable material to a predetermined coating thickness 32 which is determined by the height setting of the application device 26. The material is moved further by rotating the trough 4 into the region between the structure platform 12 and the exposure unit 10.

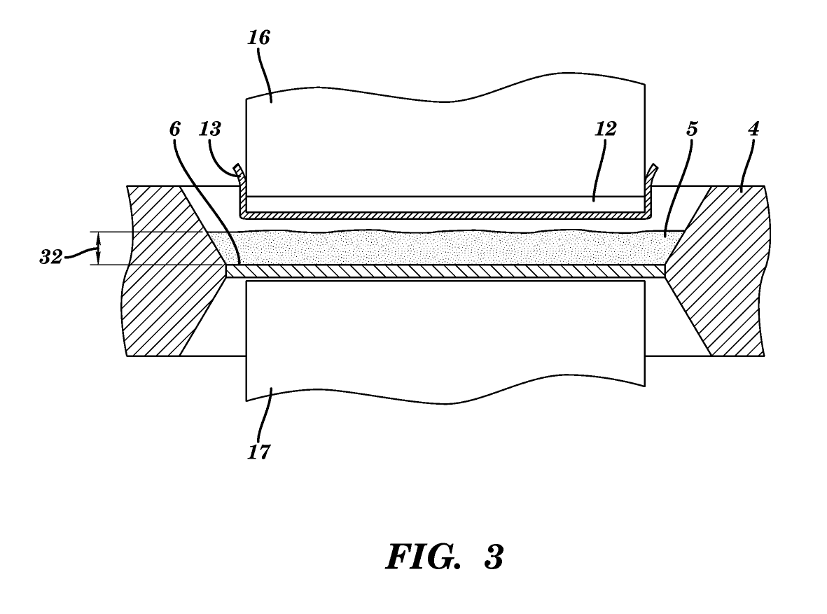

Here, after stopping the rotation movement of the trough 4, the structure platform 12 is lowered into the layer of photopolymerizable material 5 formed on the trough bottom 6, which will be explained below with the aid of FIGS. 3 to 5. In the state shown in FIG. 3, a layer of photopolymerizable material 5 with a predetermined thickness 32 is formed on the trough bottom, the structure platform 12 still being above the layer 5 in this state. A film 13, which will be discussed below, is applied on the lower side of the structure platform 12. From the state represented in FIG. 3, the structure platform 12 is now lowered using the travelling mechanism 14 controlled by the control unit 11 so that the structure platform 12 with the sheet 13 on the lower side is immersed into the layer of photopolymerizable material 5 which, when lowering further, is partially squeezed out from the gap between the sheet 13 and the upper surface of the trough bottom 6. By the travelling mechanism 14, while being controlled by the control unit 11, the structure platform 12 is lowered towards the trough bottom so that a predetermined layer thickness 21 is defined between the structure platform and the trough bottom. The layer thickness 21 of the material to be polymerized can thereby be controlled precisely.

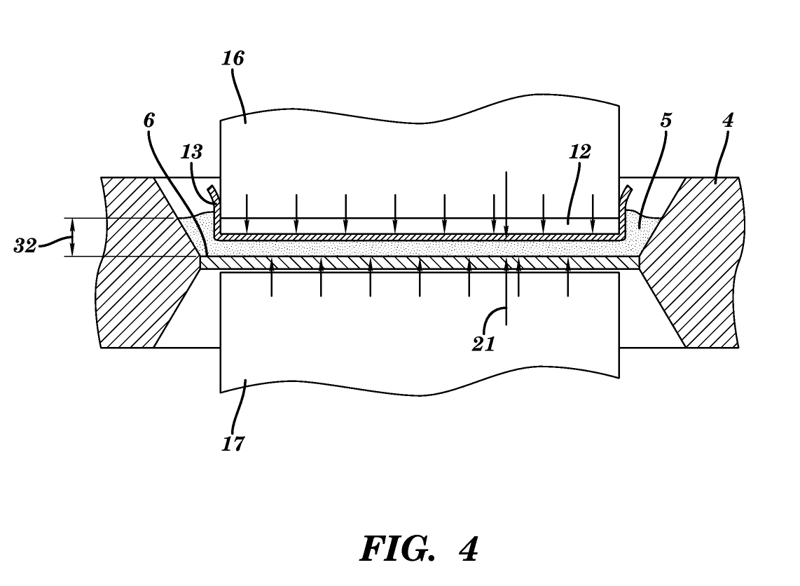

When the structure platform 12 is immersed into the photopolymerizable material 5 and lowered further into the position shown in FIG. 4, large forces may occur particularly when squeezing out highly viscous material if the structure platform is lowered with a predetermined speed. In order to prevent the material layers to be formed from being exposed to excessive forces when the structure platform 12 is lowered into the photopolymerizable material 5, the travelling mechanism contains the aforementioned force transducer 29 which measures the force exerted on the structure platform 12 and sends the measurement signal to the control unit 11. The latter is only adapted to control the travelling mechanism so that the force recorded by the force transducer 29 follows predetermined criteria, in particular that the exerted force does not exceed a predetermined maximum force. The lowering of the structure platform 12 into the photopolymerizable material 5, and the lifting of the structure platform away from it, on the one hand can therefore be carried out while being controlled in such a way that the forces exerted on the structure platform and thus on the layers already formed are limited and damage is thereby avoided when constructing the shaped body, and on the other hand the lowering and raising of the structure platform 12 can be carried out with the maximum possible speed with which damage of the shaped body to be formed is just still avoided, so as to achieve an optimal processing speed.

After the structure platform has been lowered into the photopolymerizable material 5 in the position shown in FIG. 4, the first exposure step is now carried out to polymerize the first layer 28 on the structure platform 12, in which case the further exposure unit 16 may also be operated.

Here, the device is controlled by the control unit so that the first layer is exposed by the exposure unit through a first exposure mask, the first exposure mask only allowing exposure of a first subregion of the shaped body layer to be formed. The rest of the first layer thus remains essentially unsolidified after the first exposure step.

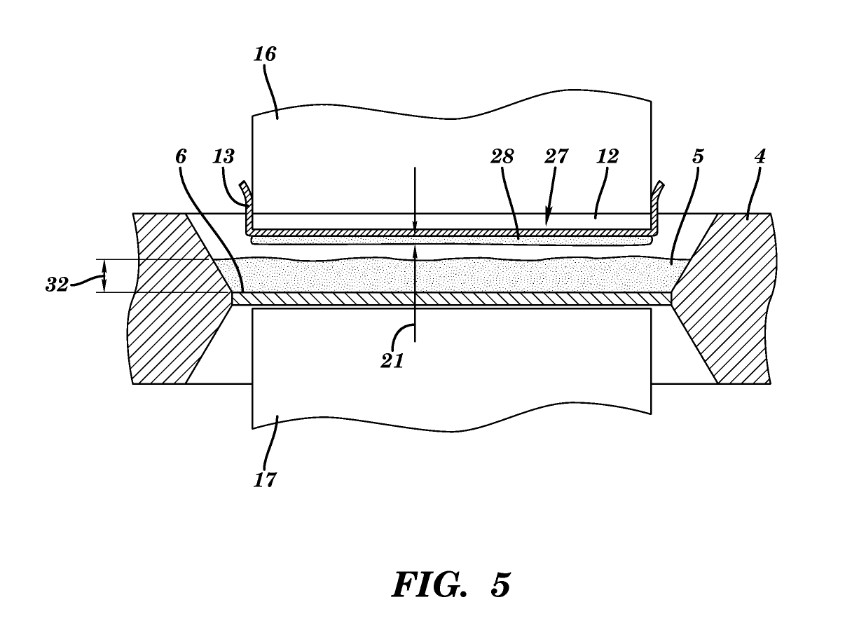

The trough 4 remains held stationary during the exposure process, i.e. the drive 24 remains switched off. After a layer has been exposed, the structure platform 12 is raised by the travelling mechanism 14. Preferably, however, a relative tilting movement is initially carried out between the structure platform 12 and the trough bottom 6 before the structure platform 12 is raised. This slight tilting movement is intended to ensure less mechanically stressful separation of the layer polymerized last on the shaped body 27 from the trough bottom 6. After this tilting movement and separation of the layer formed last, the transport platform is raised by a predetermined distance as shown in FIG. 5, so that the layer formed last on the shaped body 27 lies above the photopolymerizable material 5.

Subsequently, material is again delivered from the delivery instrument 8 and the trough 4 is rotated by the drive 24 through a predetermined rotation angle, the material moving past the doctor blade again being brought to a uniform coating thickness and a second layer being provided.

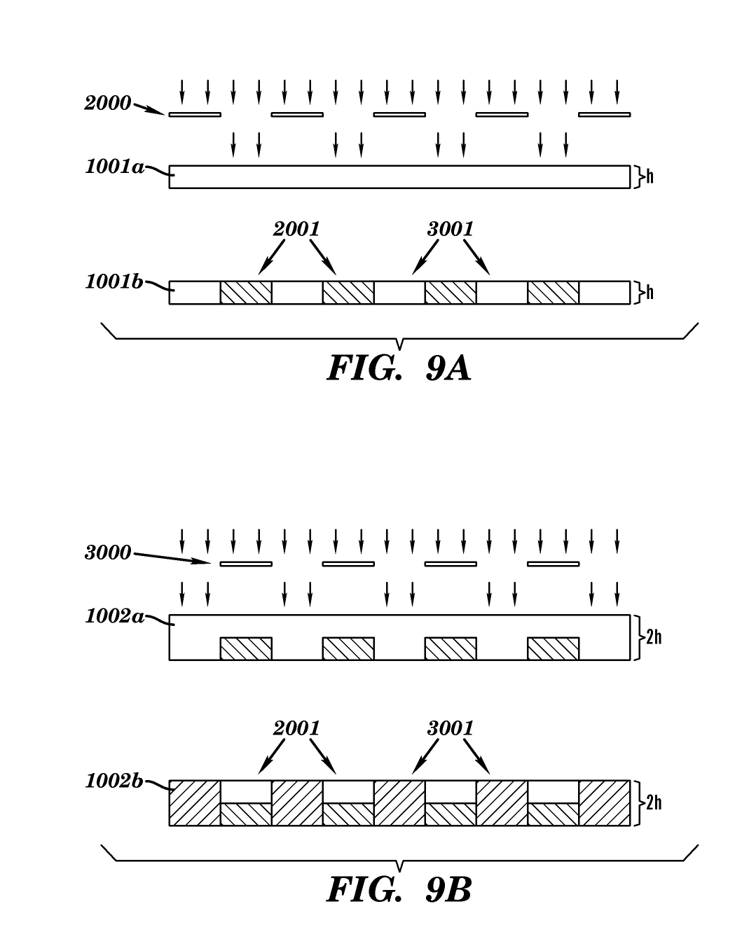

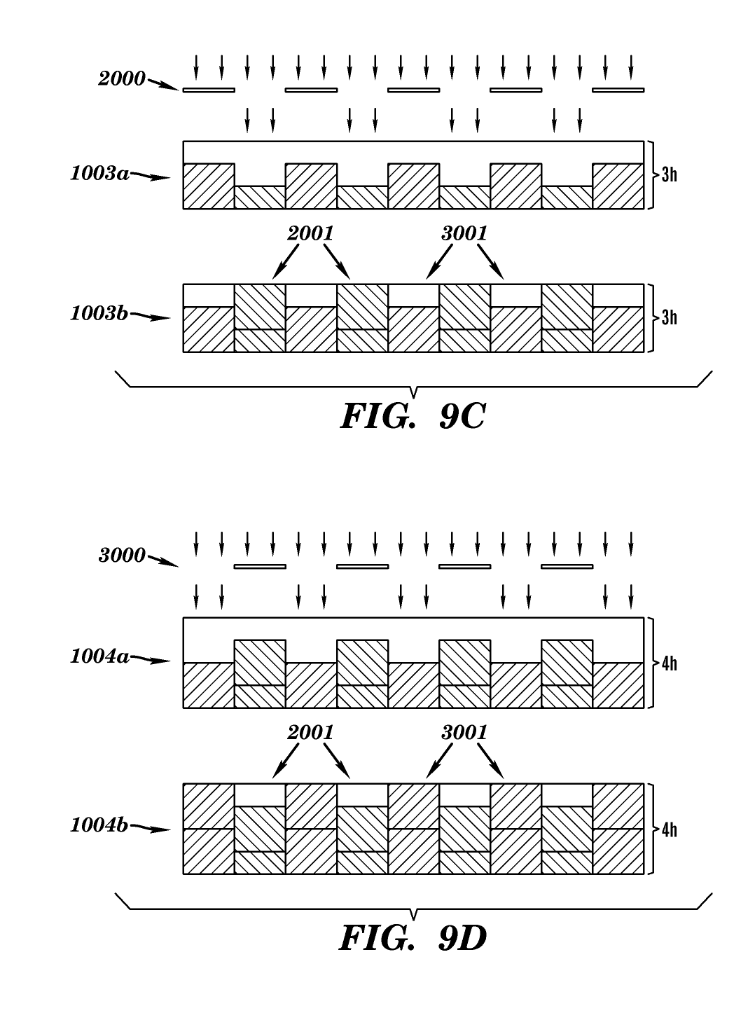

The device is then controlled by the control unit so as to carry out the method sequence schematically represented in FIGS. 9a-d, which is described in more detail below.

The squeegee 30 provided over the trough bottom 6 behind the exposure unit may have various functions. If it is lowered fully onto the trough bottom 6, for example, it can be used to collect the material from the trough bottom and remove it or return it into the delivery instrument 8; this should be done at the end of a construction process. During a construction process, if it is raised slightly relative to the trough bottom 6, the squeegee 30 serves to redistribute the material and in particular to push material back into the “holes” which have been created in the material layer by an exposure process after lifting of the structure platform 12.

Following the end of a construction process, the structure platform 12 with the exposure unit 16 fitted above are swiveled upward together by swiveling the swivel arm 18 about the articulation 20, as indicated by dashes in FIG. 1. There is then better access to the trough 4, for example in order to be able to clean or replace it.

After the described construction of the green compact from photopolymerizable ceramic-filled material, it must be removed from the device and sent to a firing oven in which destruction of the polymerized binder (binder elimination) is induced by the heat treatment and sintering of the ceramic material is carried out. In order to facilitate handling of the body which has been constructed, the structure platform is configured so that it is easily releasable from the supporting arm 18. Then, the structure platform with the constructed ceramic-filled shaped body 27 adhering to it can be taken from its support 18 and placed in a firing oven. In order to permit this preferred simple removal of the dental restoration body constructed from ceramic-filled polymer, the structure platform however must be made of a refractory material, to which end for example zirconium oxide, aluminium oxide, sapphire glass or quartz glass may be used. A self-adhesive transparent film is possible as an alternative to this, which for better adhesion may be structured on the side facing the photopolymer with pimples, grooves, slits etc., and which after the construction process can be taken from the structure platform by simple separation or the film together with the structure platform can be put into the firing oven for binder elimination/sintering.

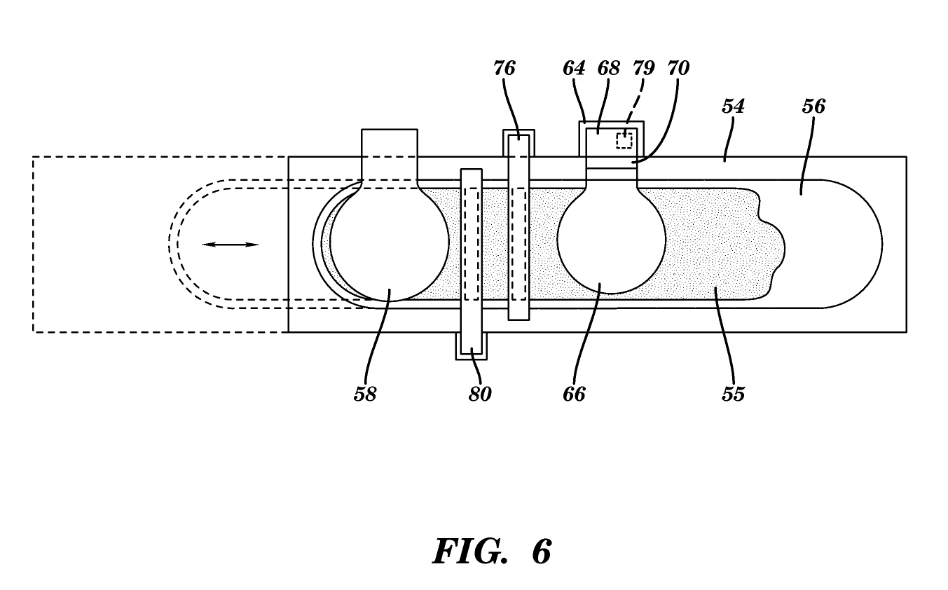

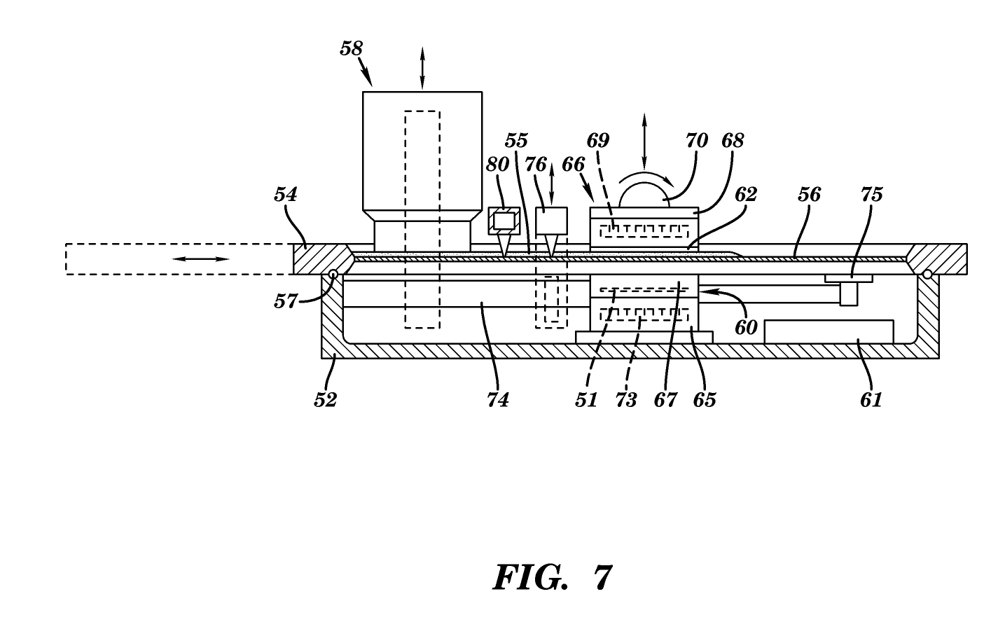

FIGS. 6 and 7 show an alternative embodiment to the device with a rotatable trough in FIGS. 1 and 2, in which the trough 54 is configured linearly mobile to and fro. In this embodiment, a trough 54 is mounted linearly mobile in a bearing 57 on the housing 52. Above the trough 54, the delivery instrument 58 is arranged in such a way that its height can be adjusted. Offset relative to the delivery instrument 58 in relation to the linear movement instrument, the structure platform 62 is held above the trough 54 on a swivel arm 68 which belongs to a travelling mechanism 64. The swivel arm 68 is in turn provided with a rotary articulation 70, which makes it possible for the swivel arm 68 to be rotated through 180° after lifting in the vertical direction, whereupon the structure platform 62 with the shaped body constructed on it faces upwards and can be handled easily in this position.

Below the structure platform 62 and the trough bottom 56, there is the projecting exposure unit 60 in which a light source 65 with light-emitting diodes 73 is arranged. The light from the light source 65 is projected through a light modulator 67 and through the transparent trough bottom 56 onto the structure platform 62. The projecting exposure unit 60 also contains a reference sensor 51, which is used in a calibration step in order to record the actual intensity distribution inside the subregion to be exposed. From the deviation of the intensity distribution actually recorded, it is then possible to calculate by inversion a drive profile (compensation mask) for the light modulator which actually ensures a uniform intensity over the subregion to be exposed. There is also a corresponding reference sensor 1 in the embodiment of FIGS. 1 and 2.

Arranged in the movement direction of the trough 54 (indicated by the double arrow in FIGS. 6 and 7), there are an application device 76 held height-adjustably above the trough bottom 56, here in the form of a doctor blade whose lower edge lies at an adjustable distance from the surface of the trough bottom, and a squeegee 80.

Apart from the difference of the linear to-and-fro movement of the trough 54 instead of the rotational movement of the trough 4, the functionality of the device shown in FIGS. 6 and 7 corresponds to the method steps described above with reference to FIGS. 3 to 5. First the trough 54 is displaced from the position shown in FIG. 7, this being caused by the control unit 61 which actuates the drive 75, leftwards into the position shown by dashed lines. Photopolymerizable material is delivered by the delivery instrument 58 onto the trough bottom 56, the quantity and time profile of the delivery likewise being predetermined by the control unit 61. By reversing the drive 75, the control unit 61 then causes the trough 54 to be displaced back again. The photopolymerizable material 55 delivered onto the trough bottom 56 initially passes through the squeegee 80 and then the application device 76 which ensure uniform distribution and a uniform coating thickness of the photopolymerizable material 55, before it reaches the gap between the structure platform 62 and the projecting exposure unit 60. The drive 75 is then stopped, whereupon the sequence of steps as described above in connection with FIGS. 3 to 5 is carried out, the structure platform 62 being immersed into the layer of photopolymerizable material 55 and a layer with a predetermined thickness between the structure platform and the trough bottom being defined by adjusting the distance from the trough bottom. The projecting exposure unit 60 is then operated in order to generate an exposure pattern with a predetermined geometry, in conjunction with which the further exposure unit 66 with its light-emitting diodes 69 is also operated at least for generating the first layer directly on the structure platform, in order to achieve complete polymerization and reliable adhesion of the first layer on the structure platform 62.

After polymerization of the first layer with the desired geometry, the structure platform 62 is raised again by actuating the travelling mechanism 64 so that the polymerized layer which has been formed is raised above the level of the photopolymerizable material 55.

The described sequence of steps is then repeated, i.e. the trough 54 is displaced to the left again, photopolymerizable material is delivered from the delivery instrument 58 and is distributed uniformly by the squeegee 80 and the application device 76 when the trough 54 is slid back to the right, whereupon after switching off the drive 75 the travelling mechanism 64 lowers the structure platform again so that the polymerized layer formed last is immersed into the photopolymerizable material 55 and brought to a predetermined distance above the trough bottom, such that the material layer now lying in the gap can be polymerized in the next exposure step. The increment of the to-and-fro movement may naturally be varied again in order to prevent the polymerization from always being carried out over the same position of the trough bottom.

The travelling mechanism 64 is in turn provided with a force transducer 79 whose measurement values are used by the control unit 61, as described above in connection with the first embodiment, in order to limit the force exerted on the structure platform when the structure platform is lowered and raised.

Preferably, methods may also be used in which a plurality of ceramic-filled photopolymerizable materials are used to construct the green compact. This may for example be done by providing a multiplicity of troughs, each with an allocated reservoir of different materials. These may be moved in the manner of a changer cassette to the exposure unit and the structure platform, in order to process different materials in a predetermined order. To this end the plurality of troughs may for example be arranged in series with one another on a support, which will then be linearly mobile with respect to the exposure unit and the structure platform in order to provide a desired trough in each case. As an alternative a multiplicity of rotatable troughs, one of which is represented in FIGS. 1 and 2, may be arranged on a circular ring of a larger plate which in turn is also rotatable so that, by adjusting the rotation setting of the disc, a desired trough can in each case be brought into the position between the exposure unit and the structure platform where the step of polymerizing the respective layer is then carried out.

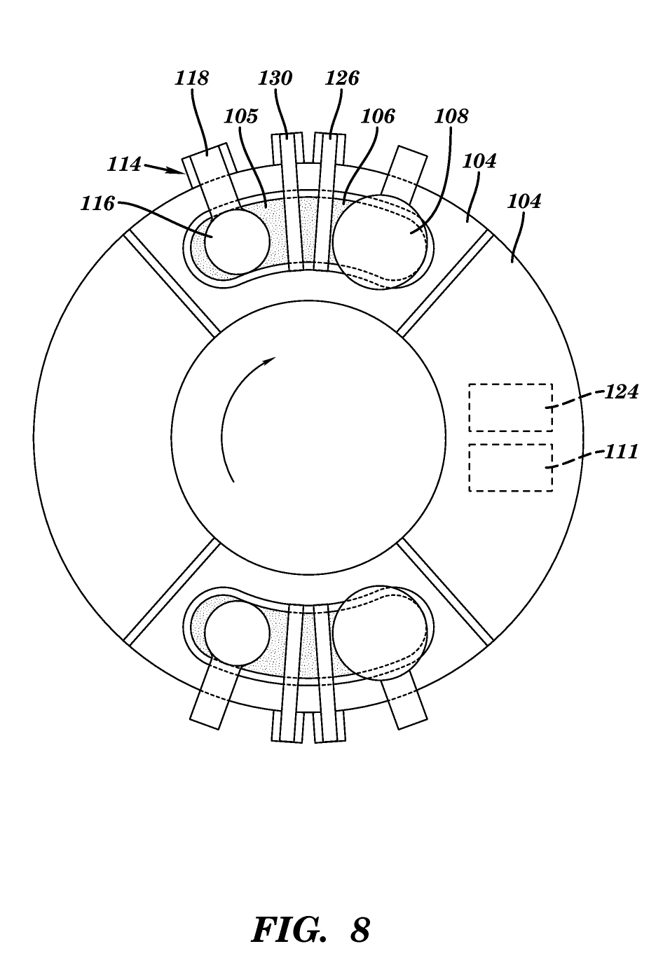

A particular embodiment of a device, with which different photopolymerizable materials can be used to construct a shaped body, is shown in a schematic plan view from above in FIG. 8. Here, there are four troughs 104 in a circular arrangement on a turntable. The arrangement of the delivery instrument 108, the further exposure unit 116 on a travelling mechanism 114 as well as the squeegee 130 lying between them, and the application device 126, is substantially similar to the arrangement of the device in FIGS. 6 and 7 except for the fact that the components are not arranged along a linear path and the trough is not linearly mobile; rather, the components are arranged along an annular segment and the trough correspondingly has the shape of a circular ring segment. Between successive exposure steps in the same trough 104, the trough is moved to and fro through an angle of approximately less than 90° so that a to-and-fro movement is in turn obtained between the delivery instrument 118 and the structure platform located below the further exposure unit 108.

If one of the materials from one of the other three troughs 104 is intended to be used at a particular time, the turntable will correspondingly be rotated through an angle of 90°, 180° or 270° in order to bring one of the subsequent troughs to the device in question for constructing the shaped body.

As indicated at the bottom in FIG. 8, another device for constructing shaped bodies, which can operate in parallel with the device presented above, may be provided in the region of another annular segment on the turntable.

The method according to the invention is illustrated schematically by FIGS. 9a-d and 10a,b, based by way of example on exposure of the layers from above. Before the individual exposure steps 1001, 1002, 1003, 1004, a new layer with a layer thickness h is respectively provided on the layer structure already constructed, or on a structure platform 12, 62 before the first exposure step 1001, so as respectively to provide the layer structure 1001a, 1002a, 1003a, 1004a. After the individual exposure steps 1001, 1002, 1003, 1004, the constructed layer composite comprises the respectively shown layer structure 1001b, 1002b, 1003b, 1004b, the solidified regions being represented by hatching.

The cross-sectional view of details in FIGS. 9a-d illustrates the mutual interlocking of the layers, which leads to the desired increase in the strength of the shaped body 27. As shown in FIG. 9a, after a first step 1001 of exposing a first layer provided, using a first exposure mask 2000 a layer structure 1001b is obtained in which a first subregion 2001 (hatched) is solidified and a second subregion 3001 (not hatched) is still unsolidified.

Once a second layer has been provided on the first layer still unsolidified in the second subregion 2001 and a layer structure 1002a has thus been achieved, as shown in FIG. 9b, after a second exposure step 1002 using a second exposure mask 3000, which is complementary with the first exposure mask 2000, a layer structure 1002b is obtained in which the second subregion 3001 is solidified and the unhatched first subregion 2001 of the second layer is still unsolidified. Here, it is clear that the penetration depth of the electromagnetic radiation reaches beyond the first layer so that it is solidified sufficiently in the second subregion together with the second layer. After the second exposure step 1002, the first layer is thus fully solidified over the entire surface of the shaped body layer to be formed.

The generative production of the shaped body 27 is successively continued in this way and a three-dimensional layer structure, which forms the shaped body 27, is thereby generated. Thus, once a third layer has been provided on the second layer still unsolidified in the first subregion 2001 and a layer structure 1003a has been achieved, as shown in FIG. 9c, after the third exposure step 1003 in which the first exposure mask 2000 is again used, the layer structure 1003b is obtained in which the first subregion 2001 of the third and second layers is solidified and the second subregion 3001 of the second layer is still unsolidified.

Once a fourth layer has subsequently been provided on the third layer still unsolidified in the second subregion 3001 and a layer structure 1004a has been achieved, as shown in FIG. 9d, after the fourth exposure step 1004 in which the second exposure mask 3000 is again used, the layer structure 1004b is obtained in which the second subregion 3001 of the fourth and third layers is solidified and the first subregion 2001 of the fourth layer is still unsolidified.

This may be continued over a multiplicity of steps, in order to form the shaped body 27. The first exposure mask 2000 is respectively used for exposure of the odd-numbered layers provided, and the second exposure mask 3000 is respectively used for exposure for the even-numbered layers. It should be noted that the external shape and area of the shaped body layer to be formed may vary from layer to layer, in which case the subregions respectively exposed will be adapted accordingly.

The interlocking of the layers may be seen clearly from the layer structure 1004b. The interlocking is achieved according to the invention by each layer, except for the first and last layers, being solidified in an exposure step with the overlying layer in one subregion 2001 together and with the underlying layer in another subregion 3001. The first and last layers are solidified with the subsequent or preceding layer, respectively, only in one of the subregions 2001, 3001.

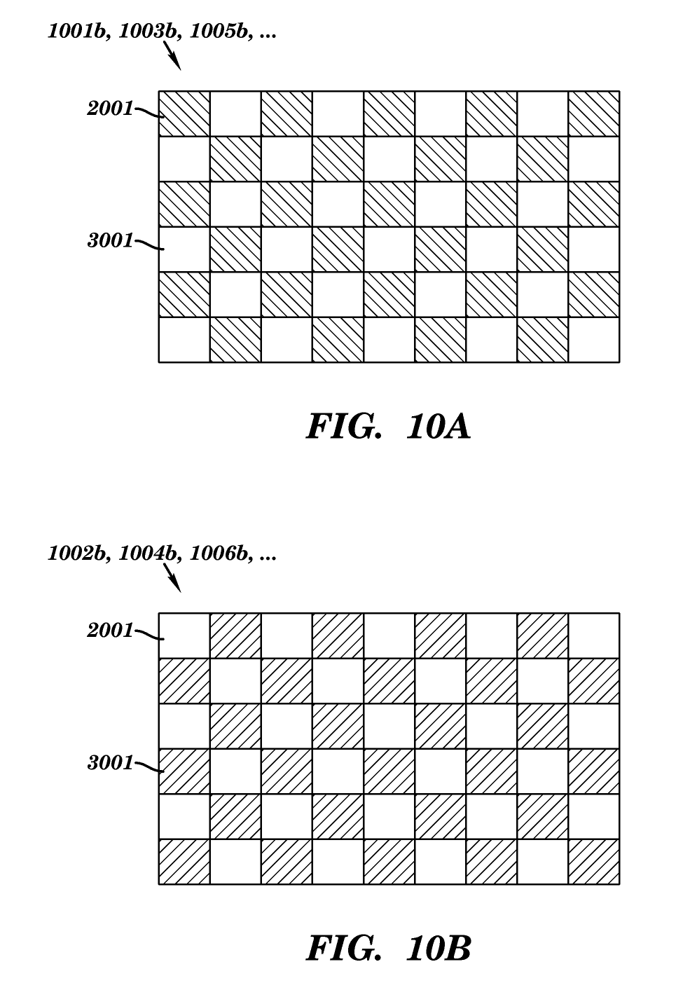

With the detail of a plan view as presented, FIGS. 10a,b show the respectively exposed new layer after the relevant exposure steps. In the odd-numbered exposure steps 1001, 1003, 1005, etc., the first exposure mask 2000 is used which has a geometry resembling a chessboard and only allows exposure of either the white or black squares. In contrast to this, the second exposure mask 3000 complementary with the first exposure mask 2000 is used in the even-numbered exposure steps 1002, 1004, 1006, etc., which has a complementary geometry resembling a chessboard and only allows exposure of the respective other fields. Every second layer which has been exposed in the first subregion 2001 thus exhibits the layer structure 101b, 103b, 105b in plan view, and the layers lying between them exhibit the layer structure 102b, 104b, 106b, etc. in which the second subregion 3001 has been exposed.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A method for the generative production of a shaped body of material solidifiable under the effect of electromagnetic radiation by a multiplicity of exposure steps comprising,
providing before an exposure step, a new layer of material solidifiable under the effect of electromagnetic radiation, having a layer thickness which is less than or equal to half the penetration depth of the electromagnetic radiation into the solidifiable material,
exposing the layer provided in the exposure step only in a subregion of the shaped body layer to be formed, a layer provided before a preceding exposure step, on which the new layer has been provided, being solidified together with the new layer in the exposed subregion, and
varying the exposed subregion between the exposure steps.

2. Method according to claim 1, wherein the subregions varied between the exposure steps essentially do not overlap and they add together to give the shaped body layer to be formed.

3. Method according to claim 1, wherein a first subregion is exposed using a first exposure mask and a second subregion is exposed using a second exposure mask, the first exposure mask essentially being complementary with the second exposure mask, and exposure being carried out using one exposure mask in every second exposure step and using the other exposure mask in the other respective exposure steps.

4. Method according to claim 1, wherein the layers have a layer thickness of 25 μm or less.

5. Method according to claim 1, wherein the luminous power is increased during a single exposure step in order to achieve better setting at greater depths.

6. A device for the generative production of a shaped body of material solidifiable under the effect of electromagnetic radiation, by a multiplicity of exposure steps comprising,
an exposure unit for exposing a shaped body layer to be formed to electromagnetic radiation,
a first exposure mask which only allows exposure of a first subregion of the shaped body layer to be formed, and a second exposure mask which only allows exposure of a second subregion of the shaped body layer to be formed, the first subregion being different from the second subregion,
a coating unit for providing a new layer of material solidifiable under the effect of electromagnetic radiation, having a layer thickness which is less than or equal to half the penetration depth of the electromagnetic radiation into the solidifiable material, and
a control unit which is configured and adapted to control the device so that a new layer previously provided by the coating unit is exposed using the first exposure mask in one exposure step and a next layer previously provided by the coating unit is exposed using the second exposure mask in the subsequent exposure step.

7. Device according to claim 6, wherein the coating unit has a trough which has an at least partially transparently designed bottom and can be filled with a photopolymerizable material, in that a structure platform having a travelling mechanism is held over the trough bottom so that its height relative to the trough bottom is adjustable, and in that the control unit is adapted to adjust the position of the structure platform relative to the trough bottom for a layer after an exposure step by controlling the travelling mechanism.

8. Device according to claim 7, wherein the exposure unit is arranged below the trough bottom for exposure from below through the at least partially transparent trough bottom.

9. Device according to claim 7, wherein the travelling mechanism contains a force transducer which is connected to the control unit and is capable of measuring the force exerted by the travelling mechanism on the structure platform and sending the measurement result to the control unit, the control unit being adapted to move the structure platform with a predetermined force profile.

10. Device according to claim 6, wherein the coating unit has a trough which is mobile in the horizontal direction relative to the exposure unit, and in that an application device whose height above the trough bottom is adjustable, for example a doctor blade or a roller, is arranged before the exposure unit in the movement direction.

11. Device according to claim 9, wherein the trough is mounted rotatably about a central rotation axis, the projecting exposure unit lying below the trough bottom and the structure platform lying above being offset in the radial direction relative to the central rotation axis, and in that a drive is provided which is capable of a rotating the trough under the control of the control unit between successive exposure steps by a predetermined angle about the central rotation axis, with a delivery instrument for delivering photopolymerizable material into the trough, the application device and the exposure unit following one another in the movement direction.

12. Device according to claim 11, wherein a squeegee, which is positionable at a predeterminable height above the trough bottom and is configured for redistribution of the material after the solidification process in the exposed subregion, is provided behind the region of the projecting exposure unit in the rotation direction.

13. Device according to claim 6, wherein light-emitting diodes are used as the light source for the exposure unit.

14. Device according to claim 12, wherein the light-emitting diodes are configured to emit light with different light wavelengths.

15. Device according to claim 6, wherein the exposure unit emits light with an average intensity of from 100 mW/dm² to 2000 mW/dm².

16. Device according to claim 15, wherein the average intensity is from 500 mW/dm² to 2000 mW/dm².
